(19) United States
(12) Patent Application Publication
(10) Pub. No.: US 2011/0273443 A1
(43) Pub. Date: Nov. 10, 2011

(54) SYSTEM AND A METHOD FOR THREE-DIMENSIONAL MODELING OF A THREE-DIMENSIONAL SCENE FEATURES

(75) Inventors: Maurice Moshe Ernst, Jerusalem (IL); Alexander Faifman, Haifa (IL)

(73) Assignees: NIPPON TELEGRAPH AND TELEPHONE CORP., TOKYO (JP); FURUKAEA ELECTRIC CO., LTD., TOKYO (JP)

(21) Appl. No.: 12/998,165

(22) PCT Filed: Aug. 12, 2009
(86) PCT No.: PCT/IB09/53554

§ 371 Date: Mar. 24, 2011

Related U.S. Application Data
(60) Provisional application No. 61/090,904, filed on Aug. 22, 2008.

(51) Int. Cl. G06T 15/00

(52) U.S. Cl. 345/419

(57) ABSTRACT

A method and a system for three-dimensional modeling of a three-dimensional scene features, are described. According to the present invention, a reference-image is captured from a known angle while an array of two-dimensional random patterns is projected onto a reference surface from another known angle. The reference image is turned in relation to the reference surface. Then, an image of the scene is captured while the array of two-dimensional random patterns is projected onto it from the same angles. By matching the patterns of these images and measuring the movement between the two projected patterns, the third dimension is computed using triangulation techniques.

### FIELD OF THE INVENTION

The present invention relates to computerized modeling of three-dimensional objects.

### BACKGROUND OF THE INVENTION

U.S. Pat. No. 7,330,577 to Ernest et al. provides a method for “Three Dimensional Modeling of the oral cavity by projecting a two-dimensional array of random patterns.” Moreover, the international publication WO 2007/080563 provides a system that operates according to the above mentioned method.

According to these references, a reference-image is captured from a known angle while an array of two-dimensional random patterns is projected onto a reference surface from another known angle and from the same angles an image of a scene is captured while the array of two-dimensional random patterns is projected onto it. By matching the patterns of these images and measuring the movement between the two projected patterns, the third dimension is computed using triangulation techniques.

As described in the above mentioned US patent, in order to unambiguously match corresponding points in the image of the intra-oral scene and in the stored image, the points of the structured illumination are spatially-modulated with two-dimensional random patterns which have been generated and saved in a projectable medium, a non-limiting example of which is a photographic slide. Unlike the prior-art random patterns of Albeck '151, the random patterns of the present invention are reproducible, so that the patterns projected onto the intra-oral scene to be imaged are the same as the corresponding patterns in the saved image. Furthermore, unlike the prior-art patterns of Corby, which are one-dimensional, the patterns of certain preferred embodiments of the present invention are two-dimensional.

The main disadvantage of this method and system is that when the surface viewed is at an angle of greater than 45 degrees to the horizontal to the projection of the pattern or to the path of return of the signal to the sensor, the signal to the sensor is diminished and the pattern is distorted beyond recognition. Therefore triangulation fails and third dimension cannot be computed.

The present invention provides a solution that overcomes this disadvantage. The main object of the present invention is that the reference image is turned and the computed calculations are done regarding to the turned reference image. Effectively, turning the reference image distorts the pattern so that it is almost identical to the distortion of the pattern by the angle of the surface. This works up to angles of 80 degrees, previously impossible using triangulation.

### SUMMARY OF THE INVENTION

The present invention is a system and a method for three-dimensional modeling of a three-dimensional scene features.

According to the present invention, a reference-image is captured from a known angle while an array of two-dimensional patterns is projected on a reference surface from another known angle. The reference image is turned in relation to the reference surface. The reference image can be turned to the capturing angle, to the projecting angle or any other angle. Moreover, the reference image can be turned to a plurality of angles and the angle that provides the best results is chosen.

Now an image of the scene is captured while the array of two-dimensional patterns is projected on it, from the same angles. By matching the patterns of these images and measuring the movement between the two projected patterns, the third dimension is computed using triangulation techniques.

According to the methods of the present invention, a system is provided for three-dimensional modeling of three-dimensional scene features. The system is comprised of:
a storage medium.
a two-dimensional array of a plurality of two-dimensional patterns, this array is stored in the storage medium.
a reference image. This reference image is of the array projected on a reference surface, wherein the array is projected from first angle and the image is captured from second angle.
a projector for projecting the array from the storage medium onto the three-dimensional scene at the first angle.
a capturing means for capturing a scene image, of the array projected on the three-dimensional scene, from the second angle.
a pattern-matching means for matching the two-dimensional patterns in the reference image with the two-dimensional patterns in the scene image.
a parallax calculator for calculating the parallax between the random patterns in the reference image with the patterns in the scene image.
at least one position calculator for calculating the two-dimensional relative positions of the patterns based on the relative positions thereof in one of the images and for calculating three-dimensional relative positions of the patterns based on the two-dimensional relative positions and the parallax.
a modeling means for constructing a three-dimensional model of the three-dimensional scene, based on the three-dimensional relative positions.

According to another preferred embodiment, the system is provided wherein the two-dimensional array is of a plurality of one-dimensional patterns.

According to another aspect of the present invention, a system is provided for three-dimensional modeling of surface features of a three-dimensional scene. This system is comprised of:
a storage medium.
a two-dimensional array of a plurality of two-dimensional patterns, the array is stored in the storage medium.
a turned-reference-image, the turned-reference-image of the array projected on a reference surface, wherein the array is projected from the first angle and the image is captured from second angle and wherein the array or the two-dimensional patterns are turned to a predetermined angle.
a projector for projecting the array from the storage medium onto the three-dimensional scene at a first angle.
a means for capturing a scene image of the array projected on the three-dimensional scene, from a second angle.
a pattern-matching means for matching the two-dimensional patterns in the turned-reference-image with the two-dimensional patterns in the scene image.
a parallax calculator for calculating the parallax between the patterns in the turned-reference-image with the patterns in the scene image.
at least one position calculator for calculating the two-dimensional relative positions of the patterns based on the relative positions thereof in one of the images and for calculating three-dimensional relative positions of the patterns based on the two-dimensional relative positions and the parallax.
a modeling means for constructing a three-dimensional model of the three-dimensional scene, based on the three-dimensional relative positions.

According to another preferred embodiment, the system also includes a computing means for creating the turned-reference-image from the captured reference image, using dedicated software.

According to another preferred embodiment, the system can operate wherein the turned-reference-image is of the array projected onto a reference surface, wherein the array or the two-dimensional patterns is turned to the first angle.

According to another preferred embodiment, the system can operate wherein the turned-reference-image is of the array projected on a reference surface, wherein the array or the two-dimensional patterns is turned to the second angle;

According to yet another preferred embodiment, the system can operate wherein the turned-reference-image is the image that provides the best results, chosen from a plurality of images wherein the plurality of images are of the array of the two-dimensional patterns—projected onto a reference surface—wherein each one is turned to a different angle.

According to another aspect of the present invention, a method is provided for three-dimensional modeling of a three-dimensional scene features. The method is comprised of the following steps:
generating a two-dimensional array of a plurality of two-dimensional patterns;
saving the array in a projectable medium;
projecting the array from the projectable medium onto a reference surface from a first angle;
capturing a reference-image of the array projected onto the reference surface, wherein the capturing of the reference image is performed from a second angle;
turning the reference-image to a chosen angle;
projecting the array from the projectable medium onto the three-dimensional scene from the first angle;
capturing a scene image of the array projected onto the three-dimensional scene from the second angle;
calculating the two-dimensional relative positions of the patterns based on the relative positions thereof in the image;
matching the two-dimensional patterns in the turned reference-image with the two-dimensional patterns in the scene image;
calculating the parallax between the patterns in the turned reference-image with the patterns in the scene image;
calculating a three-dimensional relative positions of the random patterns based on the two-dimensional relative positions and the parallax; and
constructing a three-dimensional model of the scene features based on the three-dimensional relative positions.

According to the present invention, the method is also provided wherein the turned reference image is created from the captured reference image, using a computing means and dedicated software.

The method is also provided wherein the reference-image is turned to the first angle.

The method is also provided wherein the reference-image is turned to the second angle.

The method is also provided wherein the reference-image is turned to a plurality of angles and the one that provides the best results is chosen.

According to another aspect of the present invention the reference image or the patterns or both are turned virtually.

According to yet another aspect of the present invention, at least one of the patterns is random pattern.

### BRIEF DESCRIPTION OF THE FIGURE

The invention is herein described, by way of example only, with reference to the accompanying drawing. With specific reference now to the drawing in detail, it is stressed that the particulars shown are by way of example and for purposes of illustrative discussion of the preferred embodiments of the present invention only, and are presented to provide what is believed to be the most useful and readily understood description of the principles and conceptual aspects of the invention. In this regard, no attempt is made to show structural details of the invention in more detail than is necessary for a fundamental understanding of the invention.

In the figure:

FIG. 1 illustrates the system according to the present invention.

### DESCRIPTION OF THE PREFERED EMBODIMENT

The present invention is a system and a method for three-dimensional modeling of three-dimensional scene features.

The principles and operation of the system according to the present invention may be better understood with reference to the figure and the accompanying description.

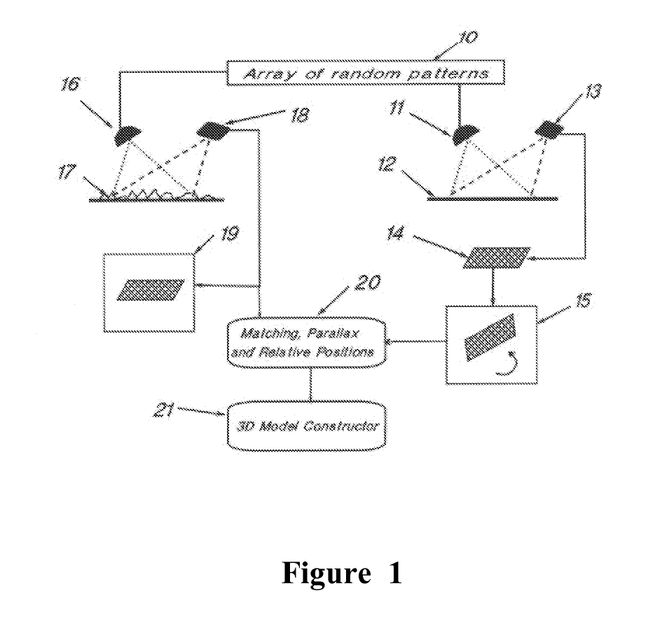

Referring now to the figure, FIG. 1 illustrates a preferred embodiment of the system. A two-dimensional array of patterns 10 is stored and projected via a projecting means 11—from a known angle—onto a reference surface 12. A capturing means 13 captures the projected array from another known angle, having a reference image 14. The reference image 14 is turned, having a turned-reference-image 15. The reference image 14 can be turned to the known capturing angle, to the known projecting angle or any other angle. Moreover, the reference image can be turned to a plurality of angles and the angle that provides the best results is chosen. The system can further include a computing means for creating the turned-reference-image from the captured reference image, using dedicated software.

Once the turned-reference-image was produced, a three-dimensional scene can be modeled. The array of patterns is projected by a projector 16 on the scene 17 and a capturing means 18 captures an image of the scene 19, while the projection and the capturing are done from the same angles as used in the reference image creation. A calculations module 20 matches the two-dimensional patterns in the turned reference-image 15 with the two-dimensional patterns in the scene image 19, then calculating the parallax between the patterns in the turned reference-image 15 with the patterns in the scene image 19 and calculating a three-dimensional relative positions of the patterns based on the two-dimensional relative positions and the parallax.

A three-dimensional model constructor 21 constructs a three-dimensional model of the scene features based on the three-dimensional relative positions.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A system for three-dimensional modeling of a three-dimensional scene features, said system comprising:
a storage medium;
a two-dimensional array of a plurality of two-dimensional patterns, said array is stored in said storage medium;
a reference image, said reference image is of said array projected on a reference surface, wherein said array is projected from first angle and said image is captured from second angle;
a projector for projecting said array from said storage medium onto said three-dimensional scene at said first angle;
a capturing means for capturing a scene image, of said array projected on said three-dimensional scene, from said second angle;
a pattern-matching means for matching said two-dimensional patterns in said reference image with said two-dimensional patterns in said scene image;
a parallax calculator for calculating the parallax between said patterns in said reference image with said patterns in said scene image;
at least one position calculator for calculating the two-dimensional relative positions of said patterns based on the relative positions thereof in one of said images and for calculating a three-dimensional relative positions of said patterns based on said two-dimensional relative positions and said parallax; and
a modeling means for constructing a three-dimensional model of said three-dimensional scene, based on said three-dimensional relative positions.

2. The system of claim 1, wherein said two-dimensional array is of a plurality of one-dimensional patterns.

3. A system for three-dimensional modeling of surface features of a three-dimensional scene, said system comprising:
a storage medium;
a two-dimensional array of a plurality of two-dimensional random patterns, said array is stored in said storage medium;
a turned-reference-image, said turned-reference-image is of said array projected on a reference surface, wherein said array is projected from first angle and said image is captured from second angle and wherein said array or said two-dimensional patterns is turned to a predetermined angle;
a projector for projecting said array from said storage medium onto said three-dimensional scene at a first angle;
a capturing means for capturing a scene image, of said array projected on said three-dimensional scene, from a second angle;
a pattern-matching means for matching said two-dimensional random patterns in said turned-reference-image with said random two-dimensional patterns in said scene image;
a parallax calculator for calculating the parallax between said random patterns in said turned-reference-image with said random patterns in said scene image;
at least one position calculator for calculating the two-dimensional relative positions of said random patterns based on the relative positions thereof in one of said images and for calculating a three-dimensional relative positions of said random patterns based on said two-dimensional relative positions and said parallax; and
a modeling means for constructing a three-dimensional model of said three-dimensional scene, based on said three-dimensional relative positions.

4. The system of claim 3, further includes a computing means operative for creating said turned-reference-image from said captured reference image, using dedicated software.

5. The system of claim 3, wherein said turned-reference-image is of said array projected on a reference surface, wherein said array or said two- dimensional patterns is turned to said first angle.

6. The system of claim 3, wherein said turned-reference-image is of said array projected on a reference surface, wherein said array or said two-dimensional patterns is turned to said second angle.

7. The system of claim 3, wherein said turned-reference-image is the image that provides the best results, chosen from a plurality of images wherein said plurality of images are of said array of said two-dimensional patterns —projected on a reference surface—wherein each one is turned to a different angle.

8. The system of claim 3, wherein the turn of said reference-image or said patterns or both is done virtually.

9. A method for three-dimensional modeling of a three-dimensional scene features, the method comprising:
generating a two-dimensional array of a plurality of two-dimensional patterns;
saving said array in a projectable medium;
projecting said array from said projectable medium onto a reference surface from a first angle;
capturing a reference-image of said array projected on said reference surface, wherein said capturing of said reference image is performed from a second angle;
turning said reference-image to a chosen angle;
projecting said array from said projectable medium onto the three-dimensional scene from said first angle;
capturing a scene image of said array projected on the three-dimensional scene from said second angle;
calculating the two-dimensional relative positions of said patterns based on the relative positions thereof in said image;
matching said random two-dimensional patterns in said turned reference-image with said random two-dimensional patterns in said scene image;
calculating the parallax between said random patterns in said turned reference-image with said patterns in said scene image;
calculating a three-dimensional relative positions of said patterns based on said two-dimensional relative positions and said parallax; and
constructing a three-dimensional model of the scene features based on said three-dimensional relative positions.

10. The method of claim 9, wherein said turned reference image is created from said captured reference image, using a computing means and dedicated software.

11. The method of claim 9, wherein said reference-image is turned to said first angle.

12. The method of claim 9, wherein said reference-image is turned to said second angle.

13. The method of claim 9, wherein said reference-image is turned to a plurality of angles and the one that provides the best results is chosen.

14. The method of claim 9, wherein at least one of said patterns is a random pattern.

15. The system of claim 9, wherein the turn of said reference-image or said patterns or both is done virtually.
